(19) United States
(12) Patent Application Publication
(10) Pub. No.: US 2026/0195985 A1
(43) Pub. Date: Jul. 9, 2026

(54) GENERATING 3D MODELS FOR MIXED REALITY APPLICATIONS USING GENERATIVE ARTIFICIAL INTELLIGENCE

(71) Applicant: simpleAR, Inc., Irvine, CA (US)

(72) Inventors: Julian Volyn, Long Valley, NJ (US); Michael Davis, Yorba Linda, CA (US); TJ Southard, Newport, NC (US); Phillip Do, Chandler, AZ (US); Marlo Brooke, Newport Coast, CA (US); Scott Toppel, Virginia Beach, VA (US)

(21) Appl. No.: 19/013,927

(22) Filed: Jan. 8, 2025

(51) Int. Cl. G06T 17/20; G06F 40/205; G06F 40/40; G06T 19/00

(52) U.S. Cl. CPC G06T 17/20; G06F 40/205; G06F 40/40; G06T 19/006

(57) ABSTRACT

A facility for generating 3D models for mixed reality applications using generative artificial intelligence displays a mixed reality (MR) development environment. The facility obtains input describing a subject of the 3D model to be generated. The input may be a textual description of the subject or an image depicting the subject. The facility determines a target MR device with which the 3D model is to be displayed. The facility establishes a prompt based on the model description and the target device, and submits the prompt to a generative artificial intelligence (AI) model. The facility receives a 3D model from the generative AI model and displays the 3D model in the mixed reality development environment. Based on the mixed reality development environment, the facility creates a mixed reality application executable by the target MR device to display the 3D model.

### CROSS-REFERENCE TO RELATED APPLICATIONS

This Application is related to U.S. application Ser. No. 18/583,357, filed Feb. 21, 2024 and entitled “DEVELOPING MIXED REALITY APPLICATIONS IN CONNECTION WITH A VIRTUAL DEVELOPMENT ENVIRONMENT,” which is hereby incorporated by reference in its entirety.

This Application is related to U.S. application Ser. No. 18/584,751, filed Feb. 22, 2024, and entitled “GENERATING STRUCTURED DATA FOR MIXED REALITY APPLICATIONS USING GENERATIVE ARTIFICIAL INTELLIGENCE”, which is hereby incorporated by reference in its entirety.

In cases where the present application conflicts with a document incorporated by reference, the present application controls.

### BACKGROUND

In a mixed reality experience, a user is presented with an environment wherein some objects in the environment are physically present with the user, and some objects are virtual objects. For example, a mixed reality experience may display a virtual torpedo in the physical environment around the user.

### BRIEF DESCRIPTION OF THE DRAWINGS

FIG. 1 is a block diagram showing some of the components typically incorporated in at least some of the computer systems and other devices on which the facility operates.

FIG. 2 is a context diagram showing an environment used by the facility in some embodiments to generate a 3D model for a mixed reality applications using generative artificial intelligence.

FIG. 3 is a flow diagram showing a process used by the facility in some embodiments to generate a 3D model for a mixed reality application using generative artificial intelligence.

FIG. 3A is a flow diagram showing a process used by the facility in some embodiments to generate a prompt for generating 3D models for mixed reality applications based on a specification of a target mixed reality device.

FIG. 3B is a flow diagram illustrating a process used by the facility in some embodiments to automatically obtain a model description for generating a 3D model for a mixed reality application using unstructured data.

FIG. 4 is a display diagram illustrating an interface used by the facility in some embodiments to receive input specifying whether to generate a 3D model for a mixed reality application.

FIG. 5 is a display diagram illustrating an interface used by the facility in some embodiments to select an input mode for generating a 3D model.

FIG. 6 is a display diagram illustrating an interface used by the facility in some embodiments to obtain a text-based model description for generating a 3D model.

FIG. 7 is a display diagram illustrating an interface used by the facility in some embodiments to obtain an image-based model description for generating a 3D model.

FIG. 8 is a display diagram illustrating an interface used by the facility in some embodiments to configure a generated 3D model for use in a mixed reality application.

FIG. 9 is a display diagram illustrating an interface used by the facility in some embodiments to receive input specifying whether to generate a 3D model for a mixed reality application.

FIG. 10 is a display diagram illustrating an interface used by the facility in some embodiments to select an input mode for generating a 3D model.

FIG. 11 is a display diagram illustrating an interface used by the facility in some embodiments to obtain an image for generating a 3D model for a mixed reality application using generative artificial intelligence.

FIG. 12 is a display diagram illustrating an interface used by the facility in some embodiments to confirm an image to be used to generate a 3D model using generative artificial intelligence.

FIG. 13 is a display diagram illustrating an interface used by the facility in some embodiments to configure a generated 3D model for use in a mixed reality application.

### DETAILED DESCRIPTION

Modern computing and display technologies have facilitated the development of systems for mixed reality experiences, in which digitally created or reproduced images or portions thereof are presented to a user in a manner that simulates interaction with the physical world. A virtual reality, or “VR”, experience typically involves the presentation of digital or virtual image information without transparency to other actual real-world visual input; an augmented reality, or “AR”, scenario typically involves presentation of digital or virtual image information as an augmentation to visualization of the actual world around the user. A mixed reality, or “MR”, experience is a type of AR experience and typically involves virtual objects (artifacts) that are integrated into, and responsive to, the natural world. For example, in an MR experience, a virtual artifact may be occluded by real world objects and/or be perceived as interacting with other objects (virtual or real) in the real world. Throughout this disclosure, reference to AR, VR or MR is not limiting on the invention and the techniques may be applied to any context.

Mixed reality experiences can be used to guide a user through an MR procedure. For example, the user may be guided through each step in a procedure for servicing a torpedo using multiple mixed reality steps. For example, an MR procedure to demonstrate how to service a torpedo may include a first MR step demonstrating how to open a service panel of the torpedo, a second MR step demonstrating how to replace a component of the torpedo accessible using the service panel, etc. In this way, mixed reality applications convey procedural information in a more intuitive and immersive way than traditional techniques such as instruction manuals, instructional videos, etc. This makes mixed reality a desirable medium for providing procedural information.

Despite the advantages of mixed reality experiences for intuitively conveying information to users, it is often impractical to create MR applications due to the expense and difficulty of obtaining assets such as 3D models. For example, an MR application demonstrating how to service a torpedo may include a detailed 3D model of the torpedo having various textures or other mappings, animations, etc. Creating such assets for 3D models for use in MR applications requires significant time and expertise. Adoption of MR applications is hindered by the difficulty and expense of producing the 3D model assets required to display the MR applications.

In response to recognizing these disadvantages, the inventors have conceived and reduced to practice a software and/or hardware facility for generating a 3D model for a mixed reality application using generative artificial intelligence (“the facility”).

In some embodiments, the facility displays a mixed reality (MR) development environment. The facility obtains, from a user, input describing the subject of a 3D model to be generated. In various embodiments, the input is a textual description of the subject or an image depicting the subject. The facility determines a target MR device with which to display the 3D model. The facility establishes a prompt based on the model description and the target device, and submits the prompt to a generative artificial intelligence model. The facility receives a 3D model from the generative artificial intelligence model, and displays the 3D model in the mixed reality development environment. Based on the mixed reality development environment, the facility creates a mixed reality application executable by the target MR device to display the 3D model.

By performing in some or all of the ways described above, the facility generates a 3D model for a mixed reality application using generative artificial intelligence. Generating 3D models for mixed reality applications enables the mixed reality applications to be created more quickly with fewer resources, and reduces the amount of tedious or repetitive work required by users to manually convert a description of a subject into a 3D model for use in an MR application. Accordingly, the facility enables MR applications to be more easily created and deployed in more contexts.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by generating a 3D model for an MR application using generative artificial intelligence, the facility reduces computing resources dedicated to providing interfaces for manually creating a 3D model. Additionally, by enabling the 3D model to be generated from within a mixed reality development environment, the facility enables a user to generate a 3D model without leaving the MR development environment to access another application for creating the 3D model, further reducing the computing resources necessary to generate a 3D model for use in a mixed reality application. In at least these ways, the facility improves the performance of computers implementing techniques disclosed herein.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, a human mind cannot display a mixed reality development environment, receive a 3D model via a generative artificial intelligence model, display the 3D model in a mixed reality development environment, or create a mixed reality application executable by a target MR device to display the 3D model.

As used herein, the term “3D model” may refer to a mesh, one or more textures, mappings, etc., or any combination thereof. In some embodiments, a 3D model includes a mesh, a texture, an animation, or any other 3D model attribute.

As used herein, the term “1K” refers to a resolution of 1024×1024 pixels; the term “2K” refers to a resolution of 2048×2048 pixels; the term “4K” refers to a resolution of 4096×4096 pixels; and the term “8K” refers to a resolution of 8192×8192 pixels. While various specific resolutions are mentioned for illustrative purposes, the disclosure is not so limited. In various embodiments, any resolution is used.

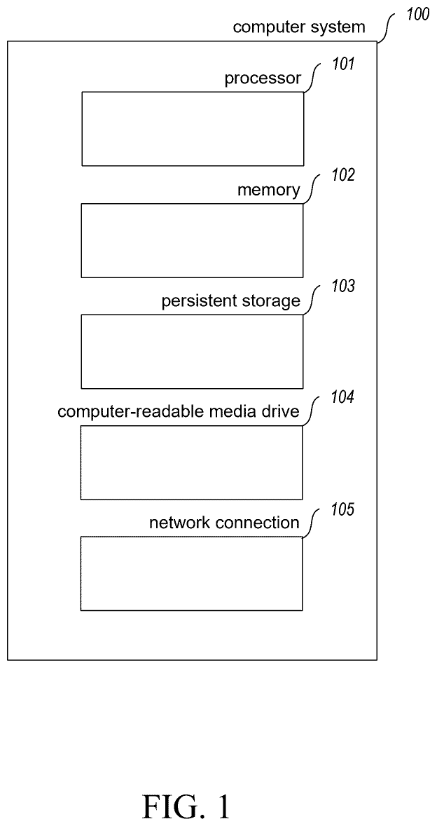

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

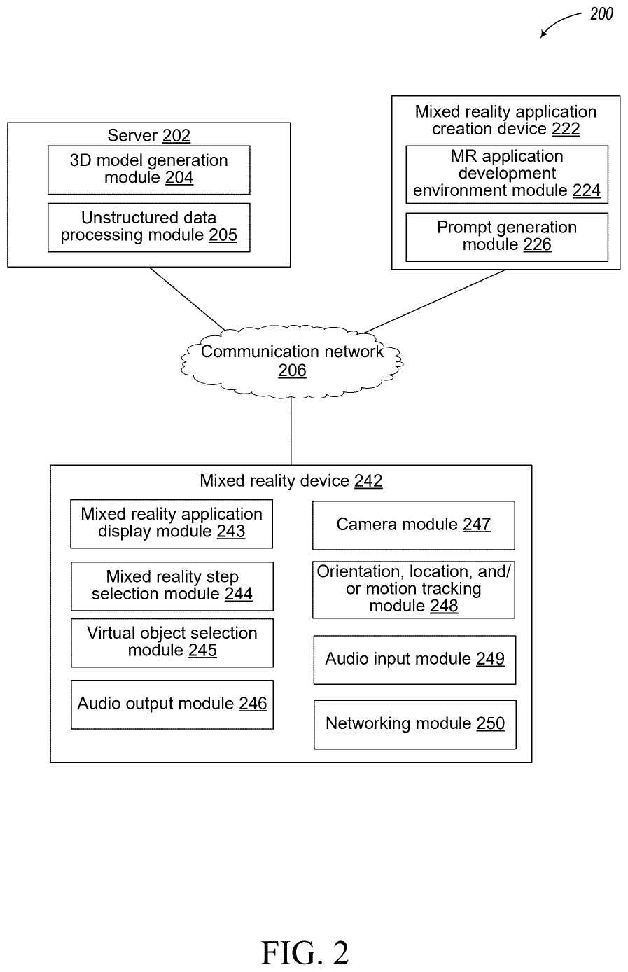

FIG. 2 is a context diagram showing an environment 200 used by the facility in some embodiments to generate a 3D model for a mixed reality applications using generative artificial intelligence. Environment 200 includes server 202, mixed reality application creation device 222, and mixed reality device 242, which communicate using communication network 206.

Mixed reality application creation device 222 (i.e., “creation device”) is configured to provide an MR development environment using MR application development environment module 224. In some embodiments, creation device 222 is a dedicated MR device such as an Apple Vision Pro®, HoloLens 2®, Magic Leap 2®, Meta Quest Pro®, etc. In some such embodiments, a user creates an MR application using gestural inputs of the MR device. In one non-limiting example, a user places 3D models in the MR application development environment using hand gestures or other methods of input available to creation device 222. The MR application development environment is then used to create an MR application that can be implemented using an MR device to display the 3D model placed using the creation device.

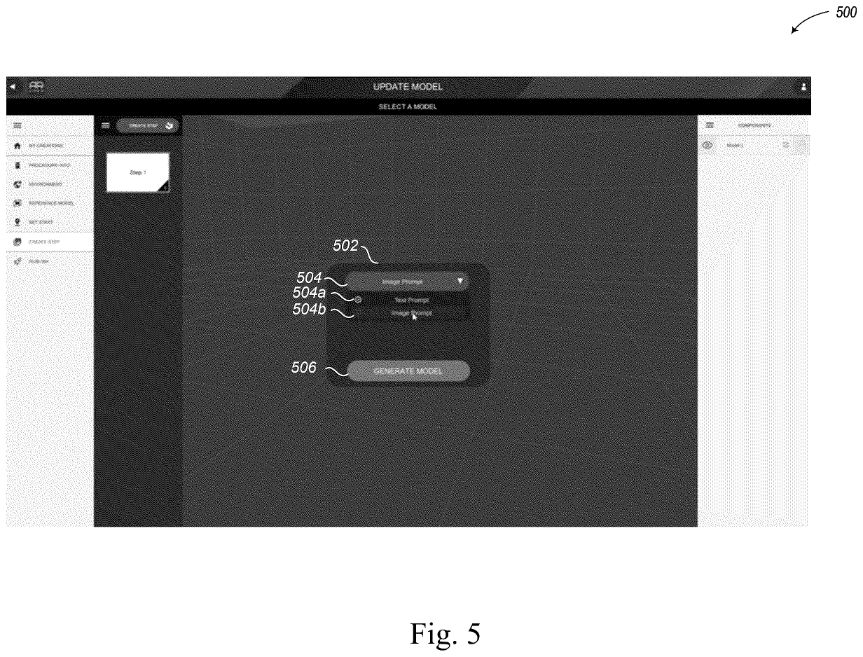

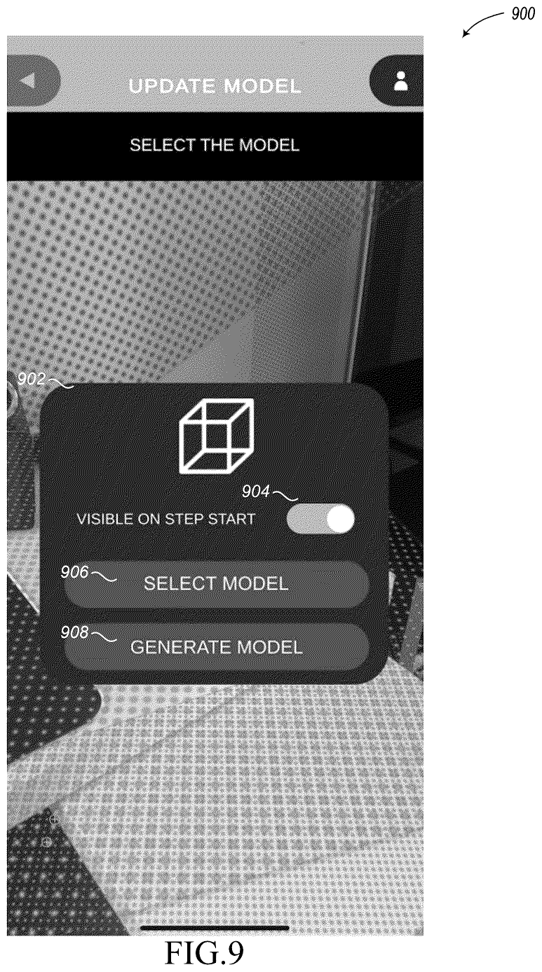

In some embodiments, creation device 222 is a smartphone, laptop, desktop computer, virtual machine, etc. Non-limiting examples of an MR application development environment provided by a desktop computer are described with respect to FIGS. 5-8. Non-limiting examples of an MR application development environment provided by a smartphone are described with respect to FIGS. 9-13.

Further examples of MR application development environments are described with respect to U.S. application Ser. No. 18/583,357, filed Feb. 21, 2024 and entitled “DEVELOPING MIXED REALITY APPLICATIONS IN CONNECTION WITH A VIRTUAL DEVELOPMENT ENVIRONMENT,” which is hereby incorporated by reference in its entirety.

Creation device 222 is also configured to generate a prompt for creating a 3D model using generative artificial intelligence using prompt generation module 226. In some embodiments, creation device 222 obtains input via the MR application development environment and creates the prompt based on the input. In one non-limiting example, a user provides input including an image depicting a subject of a 3D model to be generated. In another non-limiting example, the user provides input including a textual description of the 3D model to be generated. In various embodiments, the image is a photograph, a video frame, a computer-drawn illustration, a hand-drawn illustration, an image generated using generative artificial intelligence, etc. Prompt generation module 226 creates a prompt based on the input and provides the prompt to server 202 to generate the 3D model. Creation device 222 receives the generated 3D model and displays it using MR application development environment module 224.

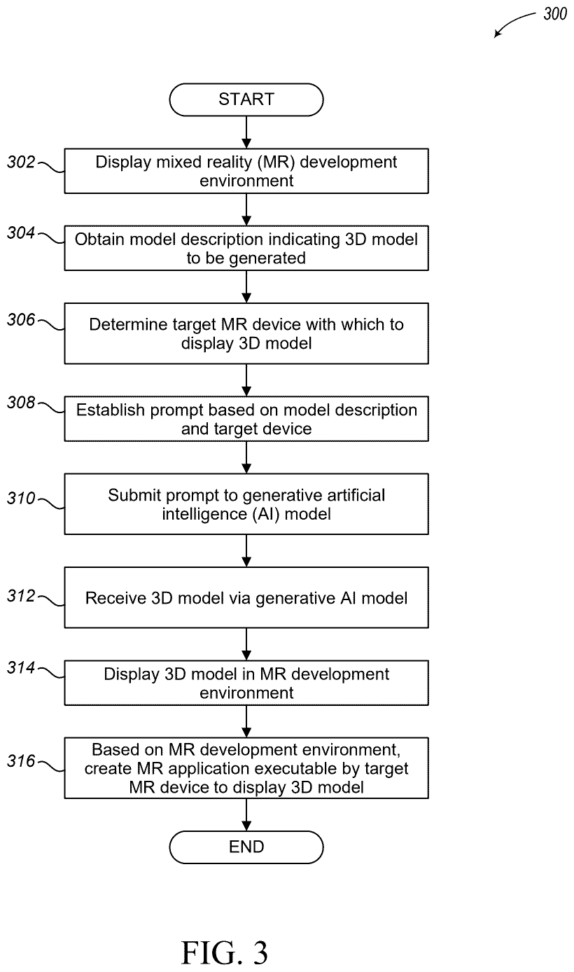

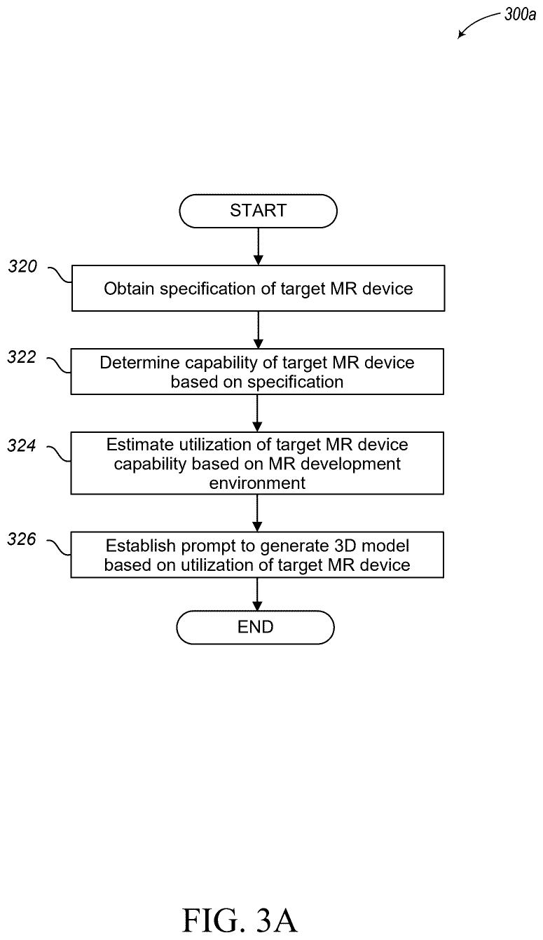

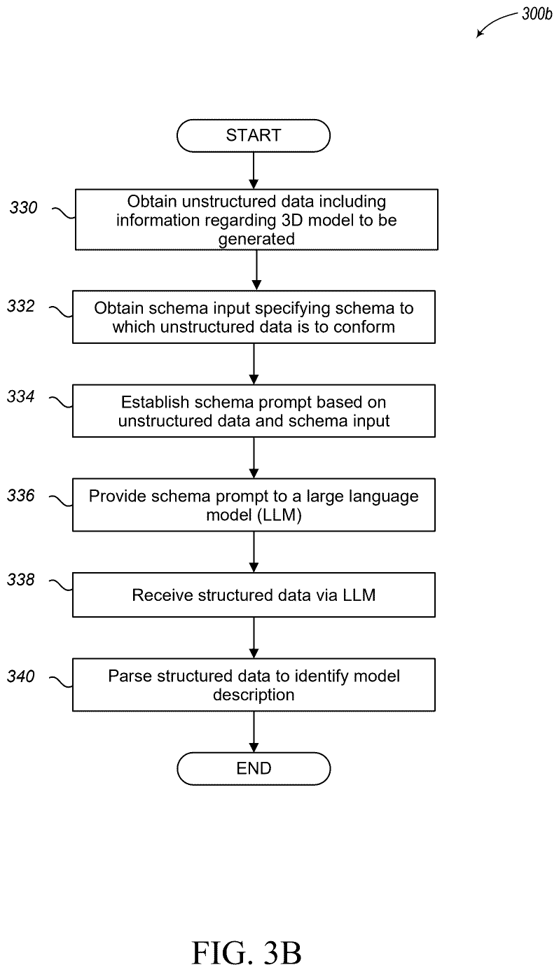

In some embodiments, prompt generation module 224 automatically generates the prompt based on unstructured data. In one non-limiting example, prompt generation module 224 obtains unstructured data associated with the MR application, such as an instruction manual describing a process for servicing a torpedo. In some embodiments, based on the unstructured data, prompt generation module 224 creates a prompt for a large language model or other generative artificial intelligence model. Using unstructured data to automatically generate a prompt for a generative artificial intelligence model is described in further detail with respect to FIG. 3B.

Server 202 includes 3D model generation module 204 and unstructured data processing module 205. Server 202 is configured to generate a 3D model for use in a mixed reality application. 3D model generation module 204 is configured to generate a 3D model based on a prompt. In various embodiments, 3D model generation module 204 employs one or more generative AI models such as Stable Diffusion, Dall-E, Midjourney, Meshy, etc. to generate the 3D model based on a prompt. Unstructured data processing module 205 is configured to generate Various embodiments of unstructured data processing module 205 are discussed with respect to FIG. 3B. In one non-limiting example, creation device 222 provides a prompt to server 202 that provides details regarding the 3D model to be generated. 3D model generation module 204 generates the 3D model and provides the 3D model to creation device 222.

Mixed reality (i.e. “MR”) device 242 is configured to provide a mixed reality experience that includes the generated 3D model. In the example shown in FIG. 2, MR device 242 includes mixed reality application display module 243; mixed reality step selection module 244; virtual object selection module 245; audio output module 246 configured to output audio, camera module 247 configured to obtain images; orientation, location and/or motion tracking module 248 configured to obtain orientation, location, and/or motion tracking data; audio input module 249 configured to obtain audio; and networking module 250 configured to enable communication with other devices via communication network 206 or other wired or wireless connections.

Mixed reality application display module 243 is configured to receive data from a camera, lidar scanner, etc., including data based on a physical reference object. Then, mixed reality device 242 provides a mixed reality experience to a viewer based on the data.

Mixed reality step selection module 244 is configured to select a step or sequence of steps to display in the MR experience. As discussed herein, an MR experience can include one or more MR steps, such as to guide a user through actions to be taken. In some embodiments, when a user has completed an MR step of an MR application, MR step selection module 244 automatically selects a subsequent MR step to display to the user. In some embodiments, MR step selection module 244 enables the user to manually select a step to display. In some embodiments, MR step selection module 244 allows the user to select a previously displayed MR step to display again. In some embodiments, MR step selection module enables the user to select any MR step in the MR experience to be displayed.

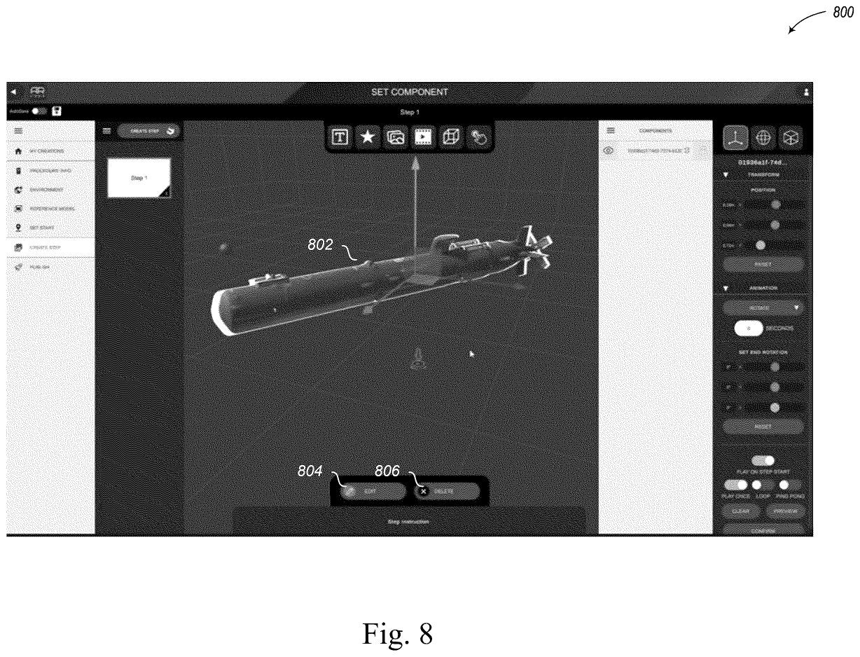

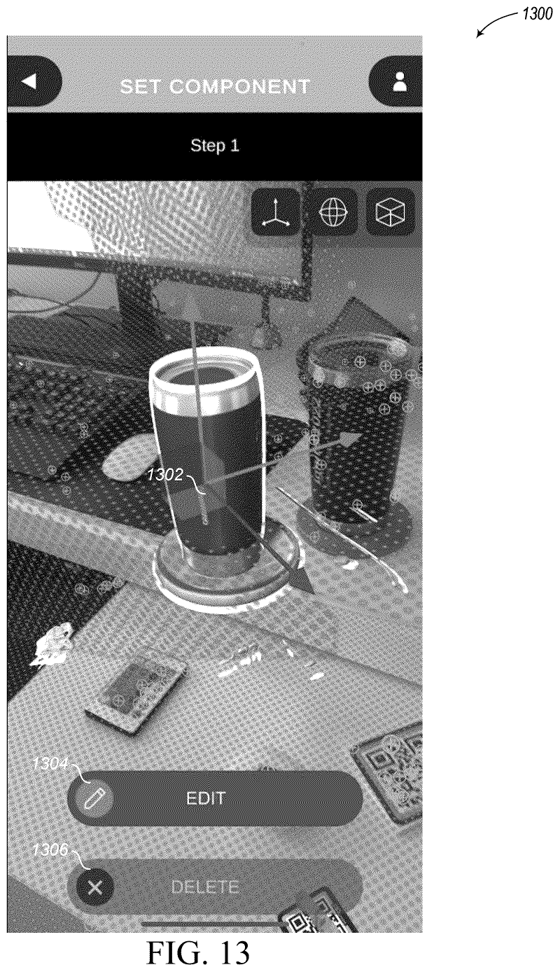

Virtual object selection module 245 is configured to select or modify a virtual object. Non-limiting examples of virtual object selection module 245 are described with respect to FIG. 8 and FIG. 13.

In various embodiments, one or more of the modules shown in FIG. 2 are implemented using a different computing device than is shown in FIG. 2. In one non-limiting example, 3D model generation module 204, or unstructured data processing module 205, or both, are implemented using creation device 222.

FIG. 3 is a flow diagram showing a process 300 used by the facility in some embodiments to generate a 3D model for a mixed reality application using generative artificial intelligence. In some embodiments, the facility performs process 300 using creation device 222 of FIG. 2.

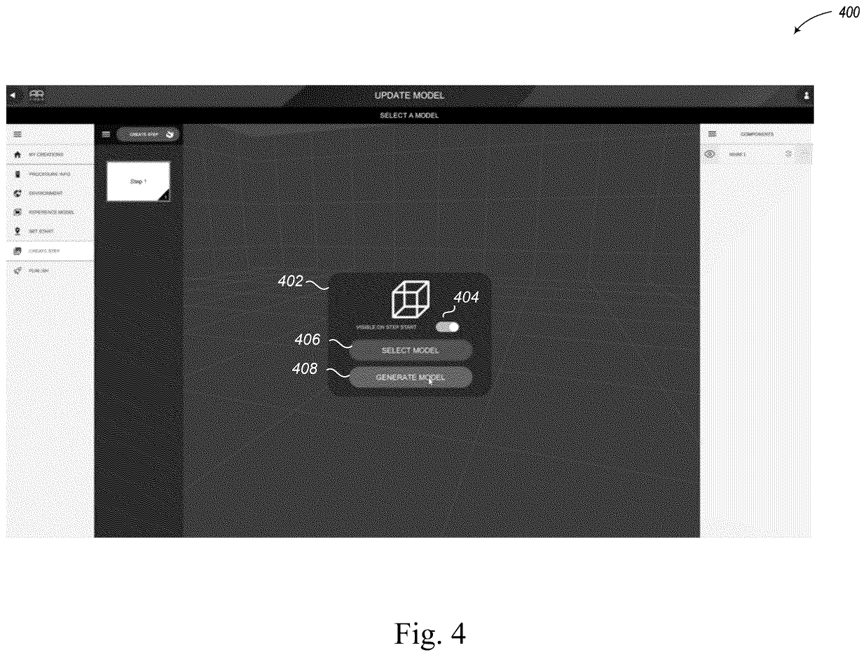

Process 300 begins, after a start block, at block 302, where the facility displays a mixed reality (MR) development environment. Non-limiting examples of the MR development environment are shown in FIGS. 4-13. After block 302, process 300 continues to block 304.

At block 304, the facility obtains a model description indicating a 3D model to be generated. In some embodiments, the model description includes a textual description of a subject of the 3D model to be generated. In one non-limiting example, when the subject of the 3D model to be generated is a torpedo, the textual description may include a description of one or more features of the torpedo. For example, the textual description that generates 3D model 1302 of FIG. 13 may include natural language description of the subject of the 3D model such as: “a black insulated tumbler with a stainless steel rim and a stainless steel base.”

In some embodiments, the model description includes one or more images of the subject of the 3D model to be generated. One non-limiting example of obtaining a model description that includes one or more images of the subject of the 3D model to be generated is discussed with respect to FIGS. 4-8.

In some embodiments, an image comprising the model description is obtained using a camera of the facility. One non-limiting example of obtaining an image comprising the model description using a camera of the facility is described with respect to FIGS. 9-13. In some embodiments, the facility obtains the image comprising the model description by obtaining selection of a preexisting digital image, such as from a file system. After the facility obtains the model description at block 304, process 300 continues to block 306.

At block 306, the facility determines a target mixed reality device with which to display the 3D model. In some embodiments, the facility determines the target MR device based on user input specifying the target device. In some embodiments the target MR device is an MR device of a plurality of MR devices having a lowest rendering capability. For example, when the lowest VRAM among the plurality of MR devices is 2 GB, the target MR device having 2 GB is selected. In some embodiments, the target MR device does not correspond to any one MR device. In one non-limiting example, a target MR device having any capabilities of the plurality of MR devices is selected. For example, when a maximum display resolution of a first MR device having a lowest maximum display resolution is 1K and a total VRAM of a second MR device having the lowest total VRAM is 2 GB, the target MR device may be determined to have total VRAM of 2 GB and a display resolution of 1K. Thus, a 3D model generated to be displayed using the target MR device may be displayable using any MR device of the plurality of MR devices. After block 306, process 300 continues to block 308.

At block 308, the facility establishes a prompt based on the model description and the target MR device. The prompt describes one or more features of the 3D model to be generated and is provided to a generative AI model to generate the 3D model. In various embodiments, the prompt includes an image-based description of the 3D model to be generated, a text-based description of the 3D model to be generated, or any combination thereof. In some embodiments, a generative artificial intelligence model used to generate the 3D model enables one or more attributes or settings to be specified for use in generating the 3D model. In some embodiments, the prompt includes one or more attributes to be used in generating the 3D model.

In various embodiments, the one or more attributes include an art style, a target polygon count, a resolution of a texture of the 3D model, whether to use quads or triangles to generate a mesh of the 3D model, whether to generate one or more textures of the 3D model, etc. As discussed herein, a 3D model may include various textures or maps such as a diffuse map, a normal map, an albedo map, a roughness map, an opacity map, a specular map, an ambient occlusion map, an emission map, etc., or any combination thereof. Accordingly, in various embodiments, the prompt is established to include or exclude any combination of textures or maps of the 3D model.

In some embodiments, the one or more attributes are included in the prompt using one or more designated fields according to a structured format, such as a representational state transfer application programming interface (i.e., “REST API”) of the generative artificial intelligence model. In some embodiments, the one or more attributes are included as natural language instructions with the model description. In some such embodiments, the facility establishes the prompt by automatically concatenating the one or more attributes to the model description. In one non-limiting example, when the model description includes “a gray torpedo,” the facility generates the prompt to include the model description as well as one or more attributes to be used in generating the 3D model. For example, the facility concatenates “resolution: 2K,” to the model description “a gray torpedo” to specify that the resolution of a texture of the 3D model is to be 2K.

In some embodiments, the facility establishes the prompt based on a specification of the target device. MR applications may be displayed using a variety of MR devices having a wide range of capabilities. For example, some MR applications may be displayed using an older smartphone or other general-purpose device, while some MR applications may be displayed using a device configured to render high-resolution stereoscopic in an immersive MR experience. Accordingly, in some embodiments, the prompt is established based on a specification of the target MR device.

In some embodiments, the facility establishes the prompt based on a display resolution of the target MR device. In some embodiments, the prompt is established to specify a texture or other asset of the 3D model based on the display resolution. In one non-limiting example, when the display resolution of the target MR device is 2K, the prompt is established to specify that the texture of the 3D model is to be 2K.

In some embodiments, where the model description includes an image, the facility establishes the prompt to specify a resolution of a texture or other asset of the 3D model based on a resolution of the image. In one non-limiting example, when the image comprising the model description has a resolution of 2K, the facility establishes the prompt to request that a texture or other asset of the 3D model be generated to have a resolution of 2K.

In some embodiments, the facility determines a resolution of the one or more textures based on a VRAM specification of the target MR device. In one non-limiting example, when an amount of VRAM of the target MR device is in a first range such as 1 GB to 4 GB, the facility selects a first resolution such as 1080p, when the amount of VRAM is in a second range such as 4 GB to 8 GB, the facility selects a second resolution such as 1440p, and when the amount of VRAM is in a second range such as above 8 GB, the facility selects a third resolution such as 2160p. In various embodiments, any number of ranges and any range thresholds are used to determine the resolution of the one or more textures.

In some embodiments, the facility determines one or more textures or other mappings to be generated based on the specification of the target MR device. 3D models often include several textures that may improve realism of the 3D model. For example, an occlusive mapping may be used to determine where indirect lighting falls on the 3D model. In some embodiments, the facility selects one or more textures to generate for the 3D model based on the specification of the target MR device. In one non-limiting example, when the target MR device has more than a threshold amount of total VRAM, the facility determines to establish a prompt that requests an occlusive mapping to be generated for the 3D model. In various embodiments, any number of thresholds corresponding to any number of textures or other 3D model assets are used.

In some embodiments, the facility determines a number of polygons to be included in a mesh of the 3D model based on a specification of the target MR device using techniques similar to those described with respect to textures.

In some embodiments, the facility determines a total rendering requirement for an MR experience including the 3D model to be displayed according to the MR development environment, obtains a rendering specification of the target MR device, compares the rendering specification and the rendering requirement, and establishes the prompt based on the comparing. In one non-limiting example, an MR development environment excluding the 3D model requires 3.5 GB of VRAM to render. If the target MR device has 4 GB of VRAM, the prompt may be established such that the 3D model requires less than 0.5 GB of VRAM to display in an MR application. For example, a resolution, number of mappings, etc. for the 3D model is selected such that a total VRAM requirement for rendering the 3D model in the MR application is less than or equal to 0.5 GB. In some embodiments, the requirement for rendering the 3D model is included in the prompt as a natural language instruction, such as “make sure the 3D model can be rendered using less than 0.5 GB of VRAM on the target MR device.” In some embodiments, the prompt includes one or more specifications of the target MR device and includes a request that the 3D model be capable of being rendered by a device having the provided specifications. In some embodiments, the prompt is established to include a performance target for rendering the 3D model using the target MR device such as a framerate, resolution, etc. As discussed herein, an MR experience is in some embodiments divided into a plurality of MR steps, wherein each MR step includes a selected combination of 3D models or other assets. In some embodiments, the total rendering requirement is determined for one or more MR steps.

In some embodiments, the rendering specification of the target MR device includes a total VRAM, a memory bus width, a memory bandwidth, GPU clock, number of processing units, etc. In various embodiments, the prompt is established such that performance of the target MR device meets a framerate, resolution, latency, or other performance target. After establishing the prompt at block 308, process 300 continues to block 310.

At block 310, the facility submits the prompt to a generative artificial intelligence (AI) model. In some embodiments, the generative AI model is implemented locally, such as using mixed reality creation device 222 of FIG. 2. In some embodiments, the generative AI model is a service implemented remotely from creation device 222, such as using server 202 of FIG. 2. After block 310, process 300 continues to block 312.

At block 312, the facility receives a 3D model via the generative AI model. In various embodiments, the 3D model includes any number of textures, polygons, etc. After block 312, process 300 proceeds to block 314.

At block 314, the facility displays the 3D model in the MR development environment. FIGS. 8 and 13 show non-limiting examples of displaying 3D models in MR application development environments.

While not shown in FIG. 3, in some embodiments the facility enables the user to submit additional information to modify the displayed 3D model. In some embodiments, process 300 returns to block 304 to receive additional description of the model to enable the 3D model to be modified. Modifying the displayed 3D model based on additional information is discussed in further detail with respect to FIG. 8. After block 314, process 300 continues to block 316.

At block 316, the facility creates an MR application executable by the target MR device to display the 3D model. In some embodiments, the facility compiles the MR application such that the target MR device can execute the MR application. After block 316, process 300 ends at an end block.

While not shown in FIG. 3, in some embodiments, process 300 causes the MR application to be provided to the target MR device.

While process 300 is described with respect to generating a 3D model, embodiments of process 300 may be used to generate a portion of a 3D model or any asset associated with the 3D model. In various embodiments, process 300 is used to generate one or more of: a diffuse map, a normal map, an albedo map, a roughness map, an opacity map, a specular map, an ambient occlusion map, an emission map, a mesh, etc., or any combination thereof. In one non-limiting embodiment, the facility receives a model description that corresponds to one or more textures and establishes a prompt to generate the one or more textures. Accordingly, the 3D model does not necessarily include a mesh and in various embodiments includes any texture or other asset.

While process 300 is described with respect to generating a single 3D model, the disclosure is not so limited. In various embodiments, embodiments of process 300 are used to generate any number of 3D models. In one non-limiting example, a plurality of 3D models are generated for use with a corresponding plurality of MR devices. In one non-limiting example, a plurality of 3D models having different rendering requirements are generated for use with a single MR device depending on a total rendering requirement of an MR experience. For example, in an MR step having a relatively high overall rendering requirement, a 3D model having relatively low rendering requirements may be used. In an MR step having a relatively low overall rendering requirement, a 3D model having relatively high rendering requirements may be used.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 3A is a flow diagram showing a process 300a used by the facility in some embodiments to create a prompt for generating a 3D model for a mixed reality application based on a specification of a target MR device. In some embodiments, block 304 employs embodiments of process 300a to establish a prompt based on a model description and a target MR device.

Process 300a begins, after a start block, at block 320, where the facility obtains a specification of a target MR device. In some embodiments, the specification includes a hardware specification of the target MR device, such as a hardware specification of a graphics adapter of the target MR device. In some embodiments, the specification includes an amount of VRAM, an amount of cache, a bus width, a bus interface, a clock speed, a memory bandwidth, a number of processing units, etc. In some embodiments, the specification of the target MR device includes a characterization of performance of the target MR device such as a value of a performance benchmark, a floating point operation performance, etc. In some embodiments, the specification includes a software specification of the target MR device such as a supported operating system, application programming interface, instruction set, etc. In various embodiments, the specification includes any combination of hardware, performance, or software specifications of the target MR device. After the facility obtains the specification of the target MR device at block 320, process 300a proceeds to block 322.

At block 322, the facility determines a capability of the target MR device based on the specification of the target MR device. In various embodiments, the capability of the target MR device includes a number of polygons per frame that can be rendered using the target MR device, a maximum memory bandwidth or size of the target MR device, a number of frames per second that can be rendered using the target MR device given a specified number of polygons to be rendered or rendering resolution, or any other capability. In some embodiments, determining the capability of the target MR device is based on an algorithm. In one non-limiting example, when an amount of VRAM of the target MR device is 8 GB, a capability of the target MR device to store assets in VRAM is 8 GB. After block 322, process 300a proceeds to block 324.

At block 324, the facility estimates a utilization of the target MR device capability. In some embodiments, the utilization includes a sum of resources of the target MR device used to render each virtual object in an MR step. In some embodiments, the utilization includes a sum of VRAM required to render each virtual object to be displayed in a mixed reality step. In some embodiments, the utilization includes a memory bandwidth required to render each virtual object in a mixed reality step. In one non-limiting example, rendering each virtual object of the MR step requires 7.5 GB of 8 GB of VRAM of the target MR device. Accordingly, the target MR device has up to 0.5 GB of VRAM that can be allocated to rendering a 3D model. After block 324, process 300a proceeds to block 326.

At block 326, the facility establishes a prompt to generate a 3D model based on the utilization. Continuing the above example, the prompt is established to generate a model that consumes less than or equal to 0.5 GB of VRAM to avoid degrading performance of the target MR device while displaying the MR step.

While process 300a is described in terms of a single specification of the target MR device, in various embodiments the facility uses a number of specifications to establish the prompt to generate the 3D model. After block 326, process 300a ends at an end block.

FIG. 3B is a flow diagram illustrating a process 300b used by the facility in some embodiments to automatically obtain a model description for generating a 3D model for a mixed reality application using unstructured data. In various embodiments, block 304 of process 300 shown in FIG. 3 employs embodiments of process 300b to obtain a model description indicating a 3D model to be generated. Techniques for extracting structured data such as a 3D model description from unstructured data using generative artificial intelligence are further described in U.S. application Ser. No. 18/584,751, filed Feb. 22, 2024, and entitled “GENERATING STRUCTURED DATA FOR MIXED REALITY APPLICATIONS USING GENERATIVE ARTIFICIAL INTELLIGENCE”, which is hereby incorporated by reference in its entirety.

Process 300b begins, after a start block, at block 330, where the facility obtains unstructured data including information regarding a 3D model to be generated. In various embodiments, the unstructured data includes a portable document format (i.e., a “PDF”), text document, image, video, etc., or any combination thereof. In one non-limiting example, the unstructured data includes a PDF manual for servicing a torpedo, which includes various images and text-based descriptions of the torpedo, and steps to be taken with respect to the torpedo to. Based on this information, the facility can generate one or more MR steps including a 3D model of the torpedo. After block 330, process 300 b continues to block 332.

At block 332, the facility obtains schema input specifying a schema to which the unstructured data is to conform. In some embodiments, the schema includes a JavaScript Object Notation (i.e., “JSON”) schema, extensible markup language (i.e., “XML”) schema, hypertext markup language (i.e., “HTML”) schema, other markup language schema, other structured data schema, etc. In some embodiments, the schema input includes a command to segment the unstructured data into a sequence of MR steps defined by the input schema, and to extract the model description based on one or more of the MR steps. In some embodiments, the schema input is based on user input. After block 332, process 300b continues to block 334.

At block 334, the facility establishes a schema prompt based on the unstructured data and the schema input. In some embodiments, the schema prompt specifies a structured format to which the unstructured data is to conform. In some embodiments, the schema prompt includes one or more fields a large language model is to populate based on the unstructured data. After block 334, process 300b continues to block 336.

At block 336, the facility provides the schema prompt to a large language model (i.e., “LLM”). After block 336, process 300b continues to block 338.

At block 338, the facility receives structured data via the LLM. In some embodiments, the structured data is structured according to a format such as JavaScript Object Notation (i.e., “JSON”). In some embodiments, the structured data includes a model description. In various embodiments, the structured data conforms to a schema based on the schema input. After block 338, process 300b continues to block 340.

At block 340, the facility parses the structured data to identify a model description. In some embodiments, parsing the structured data includes identifying a field of the structured data that corresponds to the model description. After block 340, process 300b ends at an end block.

FIG. 4 is a display diagram illustrating an interface 400 used by the facility in some embodiments to receive input specifying whether to generate a 3D model for a mixed reality application. In some embodiments, the facility displays interface 400 using creation device 222 of FIG. 2 such as a desktop computer. Interface 400 includes generation selection window 402, which includes visible on step start toggle 404, select model button 406, and generate model button 408.

Visible on step start toggle 404 is configured to enable selection of whether the model to be generated is visible upon start of the step. As shown in FIG. 4, step start input 404 is on, which indicates that the model to be generated will be displayed at the start of the step.

Select model input 406 is configured to cause a file system explorer or other interface whereby an existing model is selected to be displayed.

Generate model input 408 is configured to cause an interface for generating a 3D model to be displayed. In some embodiments, selection of generate model input 408 causes interface 500 of FIG. 5 to be displayed.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

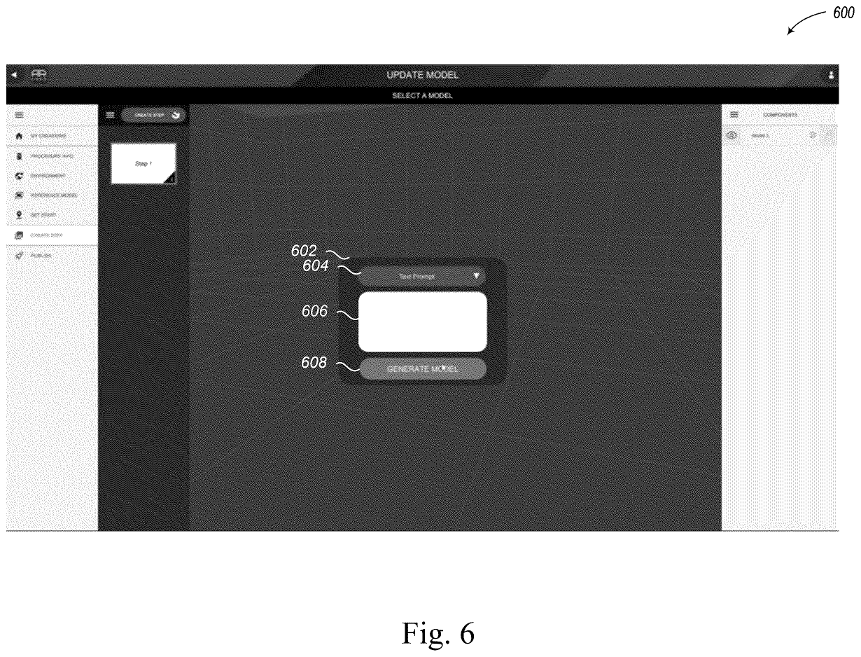

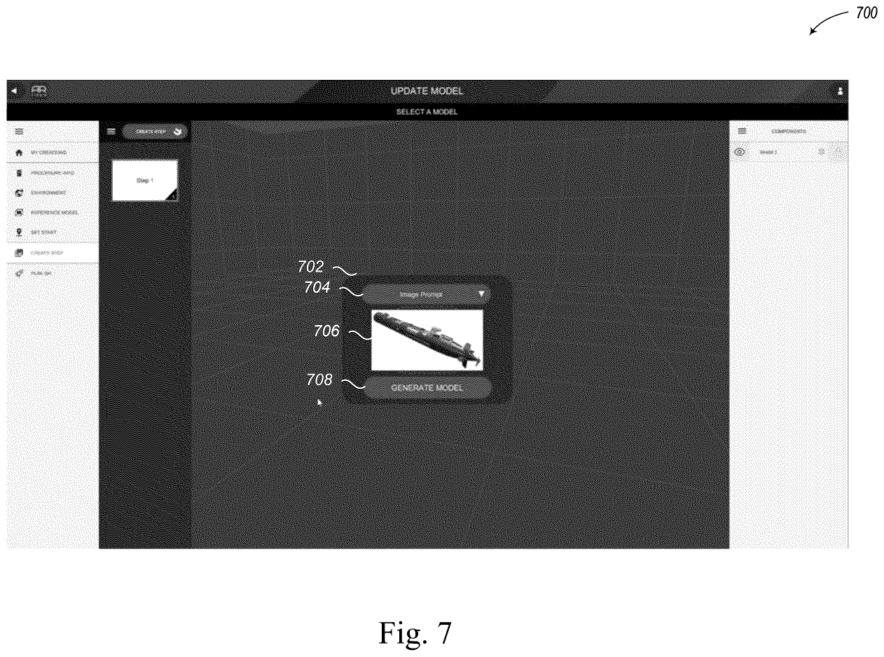

FIG. 5 is a display diagram illustrating an interface 500 used by the facility in some embodiments to select an input mode for generating a 3D model. FIG. 500 includes input mode selection window 502. Input mode selection window 502 includes input mode indicator 504, which includes text prompt 504a and image prompt 504b. As shown in FIG. 5, image prompt 504b is selected. Accordingly, upon selection of generate model input 506, the facility displays an interface for obtaining image input, such as interface 700 of FIG. 7. In some embodiments wherein text prompt input 504a is selected, selection of generate model input 506 causes the facility to display an interface for obtaining text input, such as interface 600 of FIG. 6. In some embodiments, an interface such as interface 600 or interface 700 is automatically displayed based on the selected input mode without selection of generate model input 506.

In some embodiments, the facility does not display interface 500. In some embodiments, the facility automatically determines an input mode, such as based on input received via a microphone, keyboard, etc.

FIG. 6 is a display diagram illustrating an interface 600 used by the facility in some embodiments to obtain a text-based model description for generating a 3D model. Interface 600 includes text input window 602, text input field 604, and generate model button 606. Text input window 602 includes input mode indicator 602, which is similar to input mode indicator 502 of FIG. 5. In some embodiments, text input field 604 enables the facility to receive text input. In some embodiments, generate model button 606 is similar to generate model button 506 of FIG. 5.

FIG. 7 is a display diagram illustrating an interface 700 used by the facility in some embodiments to obtain an image-based model description for generating a 3D model. Interface 700 includes image input window 702. Image input window 702 includes input mode selector 704, input image field 706, and generate model button 708. In some embodiments, input image field 706 enables an input image to be dragged and dropped into image field 706. In some embodiments, selection of image input field 706 causes an interface for selecting the input image to be displayed, such as a file selection interface. In some embodiments, input image field 706 displays a currently selected image or a thumbnail or preview thereof.

FIG. 8 is a display diagram illustrating an interface 800 used by the facility in some embodiments to configure a generated 3D model for use in a mixed reality application. Interface 800 includes 3D model 802, edit button 804, and delete button 806.

In some embodiments, selection of edit button 804 causes an editing window, such as an editing window similar to text input window 602 of FIG. 6, to be presented. Based on modification input received via the editing window, the facility creates a modification prompt to request the generative AI model to modify 3D model. For example, when 3D model 802 includes an incorrect color, a user may select edit button 804 and provide modification input instructing the generative AI model to modify or regenerate 3D model 802.

Delete button 806 is configured to enable deletion of 3D model 802. In some embodiments, selection of delete button 806 causes 3D model 802 to be deleted.

FIG. 9 is a display diagram illustrating an interface 900 used by the facility in some embodiments to receive input specifying whether to generate a 3D model for a mixed reality application. In various embodiments, interface 900 is similar to interface 400. As shown in FIG. 9, interface 900 is displayed using a smartphone. In various embodiments, the facility displays interface 900 using creation device 222 of FIG. 2.

Interface 900 includes generation selection window 902, which includes visible on step start toggle 904, select model button 906, and generate model button 908.

Visible on step start toggle 904 is configured to enable selection of whether the model to be generated is visible upon start of the step. As shown in FIG. 9, step start input 904 is on, which indicates that the model to be generated will be displayed at the start of the step.

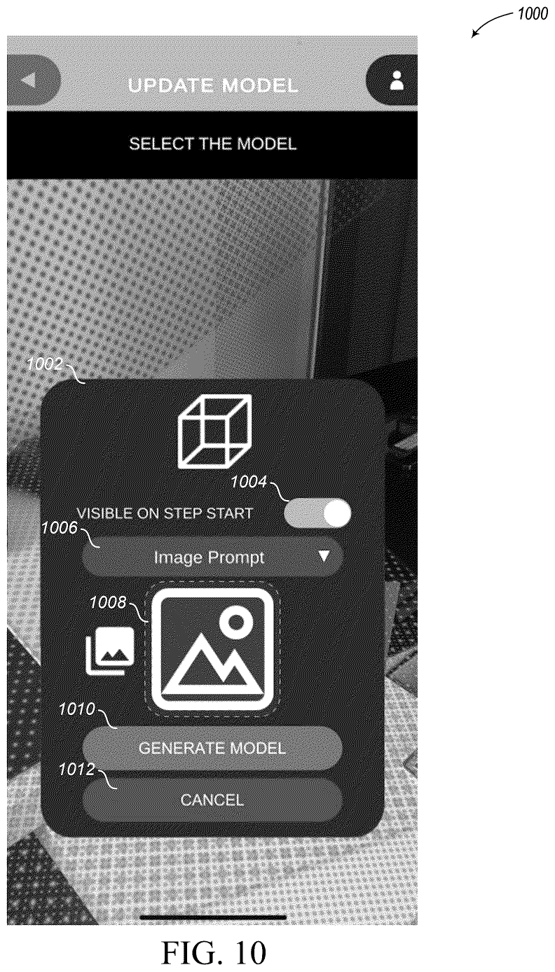

Select model input 906 is configured to cause a file system explorer or other interface whereby a model is selected to be displayed. In some embodiments, selection of select model input 906 causes interface 1000 of FIG. 10 to be displayed.

Selection of generate model button 908 causes the facility to generate a prompt based on the provided input and provide the prompt to a generative AI model to generate a 3D model according to the prompt. In some embodiments wherein a model has been selected using select model input 906, selection of generate model button 908 causes the generated 3D model to be displayed, such as in interface 1300 of FIG. 13.

FIG. 10 is a display diagram illustrating an interface 1000 used by the facility in some embodiments to select an input mode for generating a 3D model. In some embodiments, interface 1000 is similar to interface 500 of FIG. 5. In some embodiments, in response to receiving selection of image input field 1008, the facility displays interface 1100, which enables the facility to obtain an image using a camera, such as a camera of a smartphone used to display interface 1000.

Interface 1000 includes input mode selection window 1002, which includes visible on step start 1004, image input field 1008, generate model button 1010, and cancel button 1012.

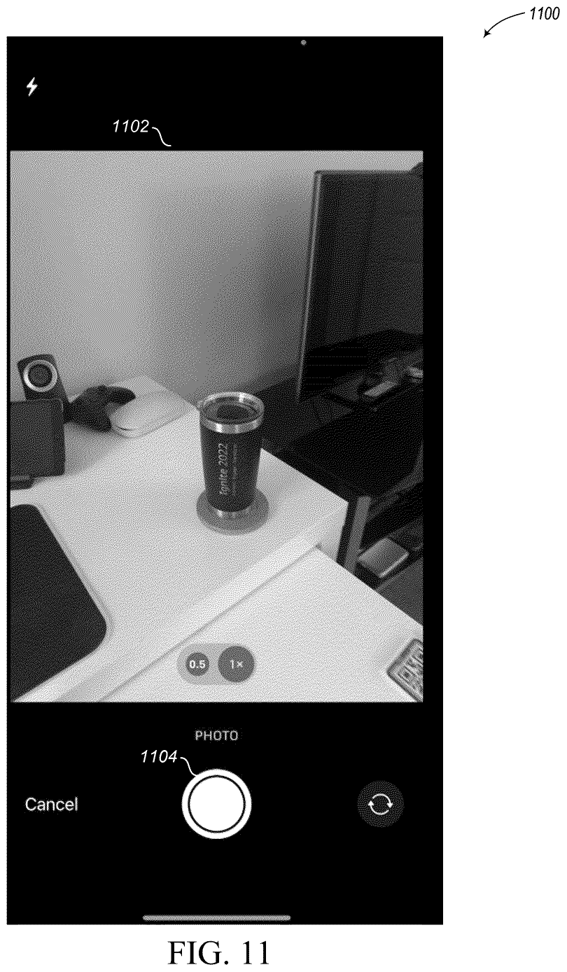

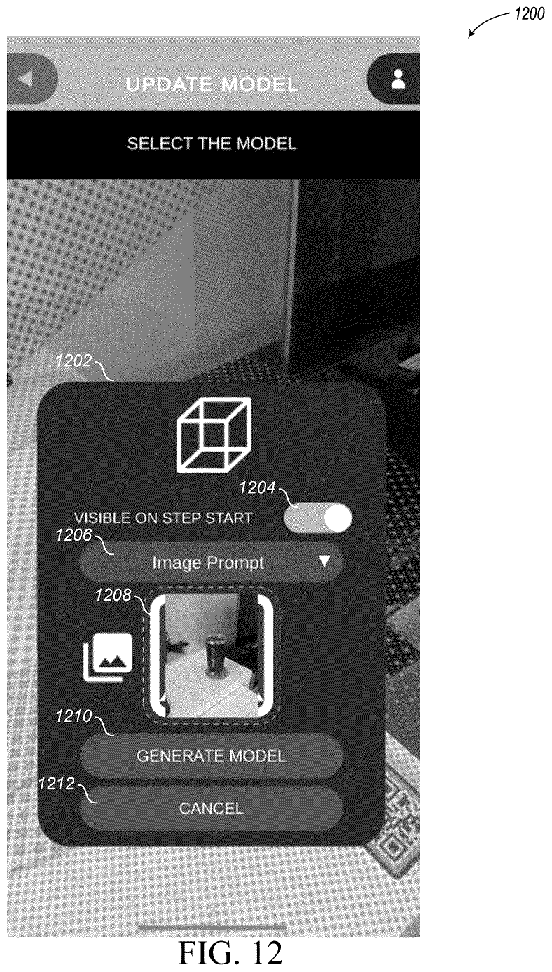

FIG. 11 is a display diagram illustrating an interface 1100 used by the facility in some embodiments to obtain an image for generating a 3D model for a mixed reality application using generative artificial intelligence. In various embodiments, interface 1100 includes an interface provided by a device used to display interface 1000, such as a smartphone. Interface 1100 includes image preview 1102 showing output of the smartphone's image sensor depicting the physical environment near the smartphone and capture button 1104. In some embodiments, selection of capture button 1104 causes the image displayed in image preview 1102 to be captured. In some embodiments, selection of capture button 1104 causes interface 1200 of FIG. 12 to be displayed. As shown in FIG. 12, the image displayed in image preview 1102 is displayed, indicating that a model is to be generated based on the image.

FIG. 12 is a display diagram illustrating an interface 1200 used by the facility in some embodiments to confirm an image to be used to generate a 3D model using generative artificial intelligence. In various embodiments, interface 1200 is similar to interface 700 of FIG. 7. Interface 1200 includes image input window 1202. Image input window 1202 includes visible on step start indicator 1204, input mode selector 1206, image input field 1208, generate model button 1210, and cancel button 1212. In some embodiments, selection of generate model button 1210 causes the facility to establish a prompt based on the image shown in image input window 1208, and provide the prompt to a generative AI model. The facility then receives a 3D model based on the prompt from the generative AI model. In some embodiments, the facility displays the 3D model in the MR development environment, such as using interface 1300 of FIG. 13.

FIG. 13 is a display diagram illustrating an interface 1300 used by the facility in some embodiments to configure a generated 3D model for use in a mixed reality application. Interface 1300 includes 3D model 1302. As shown in FIGS. 13, 3D model 1302 is generated based on the image shown in image input field 1208 of FIG. 12. Edit button 1304 enables 3D model 1302 to be edited. In some embodiments, selection of edit button 1304 causes the facility to present an interface such as interface 600 to obtain additional input to be used to create a new prompt to modify or regenerate 3D model 1302 using a generative AI model. In some embodiments, selection of edit button 1304 causes an interface for manually editing 3D model 1302 to be displayed, such as an interface for scaling, transforming, recoloring, retexturing, etc. 3D model 1302. Delete button 1306 is configured to enable deletion of 3D model 1302. In some embodiments, the facility deletes 3D model 1302 in response to receiving selection of delete button 1306.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed in a computing system, the method comprising:
displaying a mixed reality (MR) development environment;
obtaining, via the MR development environment, a model description indicating a 3D model to be generated;
determining a target MR device with which to display the 3D model;
establishing a prompt based on the model description and the target device;
submitting the prompt to a generative artificial intelligence (AI) model;
receiving a 3D model via the generative AI model;
displaying the 3D model in the mixed reality development environment; and
based on the mixed reality development environment, creating a mixed reality application executable by the target MR device to display the 3D model.

2. The method of claim 1, wherein determining the target device includes receiving user input specifying the target device.

3. The method of claim 1, wherein establishing the prompt includes:
obtaining a specification of the target device; and
establishing the prompt based on contents of the specification of the target device.

4. The method of claim 1, wherein establishing the prompt includes:
obtaining a video random access memory (VRAM) specification of the target device; and
establishing the prompt based on the VRAM specification.

5. The method of claim 1, wherein establishing the prompt includes:
determining a total rendering requirement for an MR experience including the 3D model to be displayed according to the MR environment;
obtaining a rendering specification of the target device;
comparing the rendering specification and the rendering requirement; and
establishing the prompt based on the comparing.

6. The method of claim 1, wherein determining the target MR device includes:
selecting, as the target MR device, an MR device having a lowest rendering capability among a selected set of mixed reality devices.

7. The method of claim 1, wherein the model description comprises an image.

8. The method of claim 1, wherein the model description comprises text.

9. The method of claim 1, wherein the 3D model asset comprises at least one of a diffuse map, a normal map, an albedo map, a roughness map, an opacity map, a specular map, an ambient occlusion map, a refraction map, an emission map, or a mesh.

10. The method of claim 1, wherein obtaining the model description includes:
receiving unstructured data including instructional content regarding an object that corresponds to the 3D model;
obtaining schema input specifying a schema to which the unstructured data is to conform;
establishing a schema prompt based on the unstructured data and the schema input;
providing the schema prompt to a large language model (LLM)
receiving structured data via the LLM; and
parsing the structured data to identify the model description.

11. The method of claim 1, wherein the 3D model includes a mesh and establishing the prompt comprises:
obtaining a polygon count for the mesh; and
establishing the prompt based on the polygon count.

12. The method of claim 1, further comprising:
receiving modification input indicating a modification to be made to the 3D model asset;
establishing a modification prompt based on the modification input;
providing the modification prompt to the generative AI model;
receiving, via the generative AI model, a modified 3D model;
displaying the modified 3D model in the mixed reality development environment; and
based on the MR development environment, creating an MR application executable by the target device to display the modified 3D model asset.

13. The method of claim 1, wherein establishing the prompt includes:
obtaining an image;
compressing the image; and
including the compressed image in the prompt.

14. The method of claim 1, wherein the model description includes a plurality of images of an object for which the 3D model is to be generated.

15. The method of claim 1, wherein the 3D model includes a plurality of 3D model assets, and establishing the prompt includes:
selecting a 3D model asset of the plurality of 3D model assets; and
establishing the prompt to specify that the asset of the 3D model is to be generated.

16. A system comprising:
one or more processors; and
one or more computer-readable memories storing contents executable by the one or more processors to perform actions, the actions including:
displaying a mixed reality (MR) development environment;
obtaining a model description indicating a 3D model to be generated;
establishing a prompt based on the model description;
submitting the prompt to a generative artificial intelligence (AI) model;
receiving a 3D model via the generative AI model;
adding the 3D model to the MR development environment; and
based on the MR development environment, creating an MR application executable by an MR device to display the 3D model.

17. The system of claim 16, further comprising a camera, and wherein obtaining the model description includes obtaining an image using the camera.

18. The system of claim 16, further comprising a camera, the actions further including:
providing, via the MR development environment, instructions to capture an image usable to generate the 3D model asset; and
obtaining, via the camera, the image usable to generate the 3D model.

19. One or more computer-readable memories, not constituting signals per se, storing contents executable by one or more processors to perform actions, the actions comprising:
obtaining a model description indicating a 3D model to be generated;
determining a plurality of target devices on which the 3D model is to be displayed;
obtaining a specification of each of the plurality of target devices;
establishing a plurality of prompts based on the model description and the specification of each of the plurality of target devices;
submitting the plurality of prompts to a generative artificial intelligence (AI) model;
receiving a plurality of 3D models corresponding to the plurality of target devices via the generative AI model; and
based on the plurality of 3D models, creating a plurality of mixed reality applications executable by the corresponding plurality of target devices to display the plurality of 3D models.

20. The one or more computer-readable memories of claim 19, wherein obtaining the model description includes:
obtaining unstructured data regarding an object that corresponds to a 3D model of the plurality of 3D models;
obtaining schema input specifying a schema to which the unstructured data is to conform;
establishing a schema prompt based on the unstructured data and the schema input;
providing the schema prompt to a large language model (LLM)
receiving structured data via the LLM; and
parsing the structured data to identify the model description that corresponds to the 3D model.
